(19) United States
(12) Patent Application Publication
(10) Pub. No.: US 2009/0189443 A1
(43) Pub. Date: Jul. 30, 2009

(54) Power conversion system and method thereof using pulse width modulation

(76) Inventor: Hung-Wei Lin, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,857

(22) Filed: Jun. 11, 2008

(30) Foreign Application Priority Data
Jan. 30, 2008 (TW) 097103393

(51) Int. Cl. H02J 1/00

(52) U.S. Cl. 307/12

(57) ABSTRACT

A power conversion system comprises an input unit, a control unit, a plurality of pulse width modulation (PWM) units and a plurality of conversion units. The input unit is for generating an input voltage-current, and the PWM units are connected with the input unit respectively for receiving the input voltage-current and output the PWM signals corresponding to the input voltage-current respectively. The control units are connected with the PWM units respectively for counting the number of PWM units and determining the order of the PWM units. The PWM units determine the phases of the PWM signals based on the number and order of the PWM units. The conversion units connected with the corresponding PWM units respectively are for generating a plurality of working voltage-currents corresponding to the PWM signals.

### FIELD OF THE INVENTION

The invention relates to a power conversion system and method thereof, and more particularly to a power conversion system capable of dynamically adjusting the phases of the PWM signals.

### DESCRIPTION OF THE PRIOR ART

Currently, as Pulse Width Modulation (PWM) technology and Pulse Frequency Modulation (PFM) technology mature, synchronous power system is widely applied in all kinds of AC or DC power distribution system gradually. FIG. 1 illustrates a schematic structure of the synchronous power system of prior art. An input unit 100 is for providing an input voltage-current 110 to PWM units 140˜142 which output PWM signals 130˜132 corresponding to the input voltage-current 110 respectively. The conversion units 150˜152 is for converting the PWM signals 130˜132 into working voltage-currents 120˜122 which are required by the loads 170˜172 respectively. In implement, the capacitors units 160˜162 are coupled between the input unit 100 and the PWM units 140˜142, and the input voltage-current 110 must pass the capacitors units respectively for reducing the ripple. For the regular computer, the power supply transforms the AC current (110V/60 Hz) to DC current by lowering the potential of the AC current (110V/60 Hz), then rectifying and filtering it. However, such DC current still has a slight ripple. If we use larger capacitor, the ripple will become slighter. When the DC current is inputted to the computer, the computer distributes it to the units which need power by using Pulse Width Modulation (PWM) means.

For example, the PWM units 140˜142 can supply power to CPU, the fan, the south bridge chip, and the north bridge chip respectively. However, the required power of these units are depended on work load of these units, such as the rotation speed of the fan and the quantity of usage of CPU, thus their required working voltage-currents are not stable, and the PWM units 140˜142 will generate the required working voltage-current based on the corresponding PWM signals 130˜132. However, the actual input current has ripples, and when the work load increases, the output current will be larger and the ripple of the input current will be larger as well. For reducing the ripples to maintain the stability of supplying power of the system, the larger size capacitors are required for larger output current. In prior art, the capacitors 160˜161 are used to reduce the ripples.

When being connected with more loads, the power supply system has to generate larger current and then the larger capacitor is required to keep the power supply system stable. However, the large capacitor requires bigger volume and higher cost. Presently, the asynchronous power supply system has being applied and needs smaller capacitor; however, the asynchronous power supply system only can connect fix number of the loads and has the disadvantage of extending difficultly to connect various loads.

As the above-mentioned drawbacks shown, the inventor, based on the practical experience for developing and design, provides a power conversion system and method using pulse width modulation for accomplishing the improvement in these drawbacks.

### SUMMARY OF THE INVENTION

Therefore, the objective of the present invention is to provide a power conversion system and method for solving the significantly degraded ripples while the load increases, and lack of expansion occurred in power supply system of prior art.

To achieve the foregoing objective, the present invention provides a power conversion system comprising an input unit, a control unit, a plurality of pulse width modulation (PWM) units and a plurality of conversion units. The input unit is for generating an input voltage-current, and the PWM units are connected with the input unit respectively for receiving the input voltage-current and output the PWM signals corresponding to the input voltage-current respectively. The control units are connected with the PWM units respectively for counting the number of PWM units and determining the order of the PWM units. The PWM units determine the phases of the PWM signals based on the number and order of the PWM units. The conversion units connected with the corresponding PWM units respectively are for generating a plurality of working voltage-currents corresponding to the PWM signals.

Preferably, the phases of the PWM signals are determined by dividing 360° by the number of said PWM units.

Preferably, the control unit can be a discrete unit.

Preferably, the control unit can be integrated into the PWM units.

Besides, this invention further provides a power conversion method for converting an input voltage-current to a plurality of working voltage-currents. The power conversion method includes the following steps of:

i) providing a plurality of PWM units for outputting a plurality of PWM signals corresponding to the input voltage-current;

ii) counting the number of the PWM units and determining the order of the PWM units;

iii) calculating the phase of each PWM signal based on the number and order;

iv) generating the working voltage-current corresponding to each PWM signal.

The power conversion system and conversion method thereof in accordance with the invention can dynamically adjust number of the PWM units for various loads in order to output the PWM signals of which phase are asynchronous. Therefore, the system can reduce the required capacitor efficiently and reduce the electromagnetic interference.

### BRIEF DESCRIPTION OF THE DRAWINGS

The subject matter regarded as the invention is particularly pointed out and distinctly claimed in the concluding portion of the specification. The invention, both as to system and method of operation, together with features and advantages thereof may best be understood by reference to the following detailed description with the accompanying drawings in which:

FIG. 1 is a block diagram of the power conversion system in prior art;

FIG. 2 is a block diagram of the power conversion system in accordance with the present invention;

FIG. 3 is a block diagram of the first embodiment of the power conversion system in accordance with the present invention;

FIG. 4 is a block diagram of the second embodiment of the power conversion system in accordance with the present invention;

FIG. 5A and FIG. 5B are the phase diagrams showing the asynchronous phase diagrams while the power conversion system has three PWM units and four PWM units respectively; and

FIG. 6 is a flow chart of the power conversion method in accordance with the present invention.

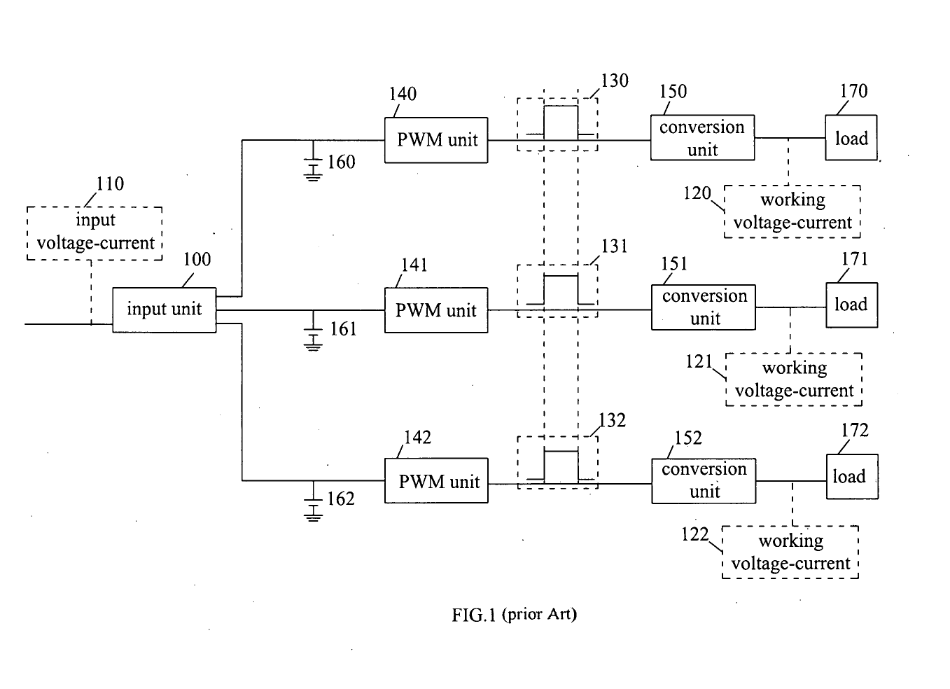

### DETAIL DESCRIPTION OF PREFERRED EMBODIMENTS

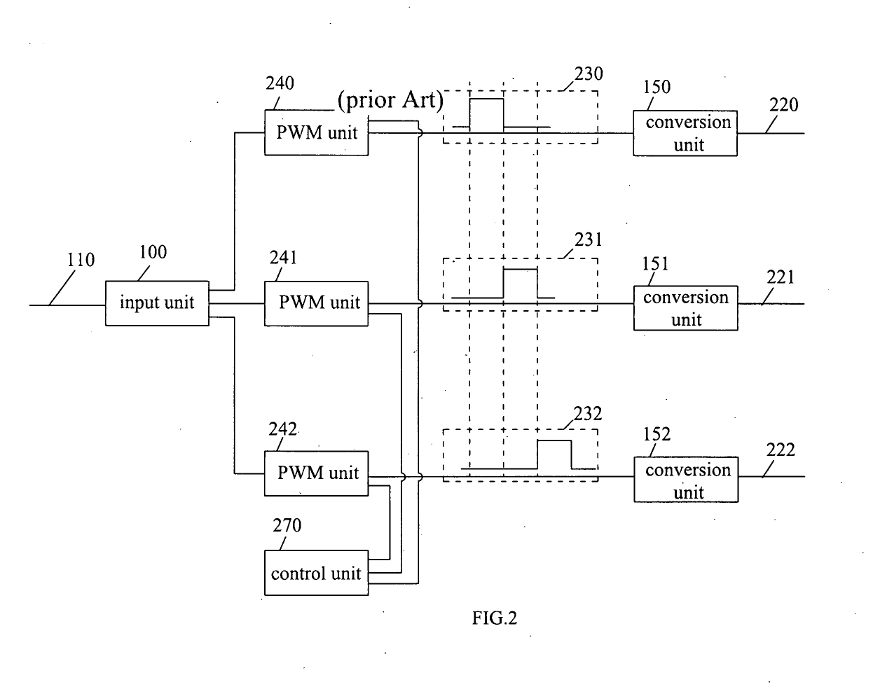

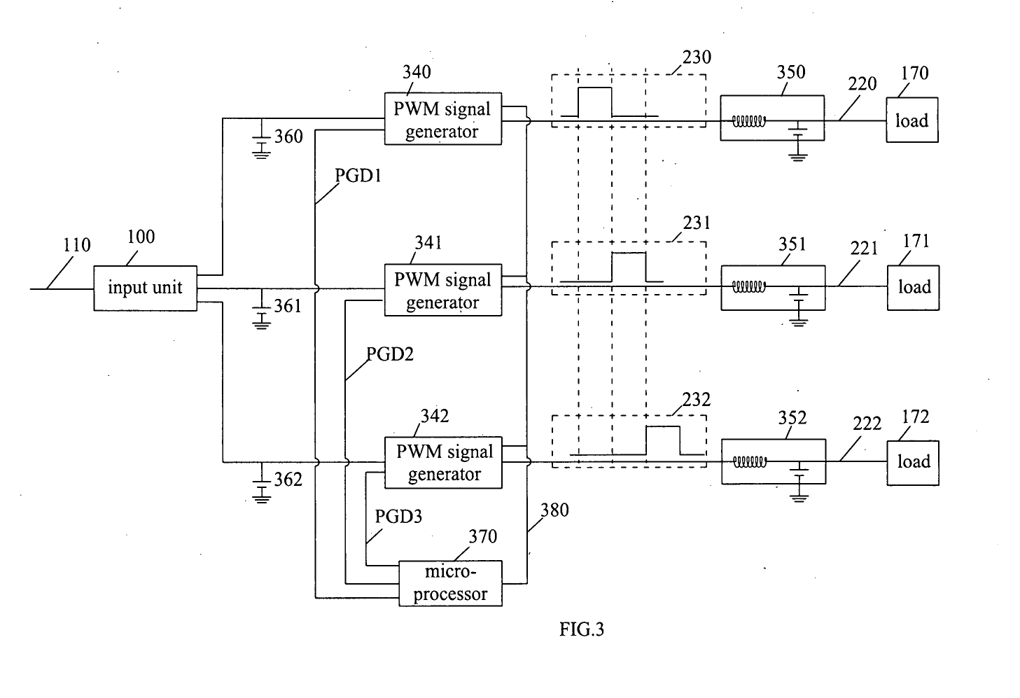

FIG. 2 and FIG. 3 illustrate a chart and block diagram of the power conversion system in accordance with the invention. The power conversion system comprises an input unit 100, a plurality of pulse width modulation (PWM) units 240˜242, a control unit 270 and a plurality of conversion units 150˜152. The PWM units 240˜242 are respectively connected with the input unit 100 which generates an input voltage-current 110 and then transmits it to the PWM units 240˜242. The PWM units 240˜242 respectively generate PWM signals 230˜232 corresponding to the input voltage-current 110. The control unit 270 is connected to the PWM units 240˜242 for counting the number of PWM units 240˜242 and detecting the order of the PWM units 240˜242. The PWM units 240˜242 determine the phases and the phase order of the PWM signals 230˜232 based on the detected order and the number of the PWM units 240˜242 to generate PWM signals 230˜232 with asynchronous phases. Preferably, the phases of the PWM signals 230˜232 is determined by dividing 360° by the number of the PWM units 240˜242.

The conversion units 150˜152 are connected with the relative PWM units 240˜242 for generating the working voltage-current 220˜222. In this embodiment, preferably, the conversion units 150˜152 can be implemented by filters, and the control unit 270 is an independent element, such as a micro-processor or an embedded controller.

FIG. 3 illustrates a block diagram of the power conversion system in accordance with the invention. The power conversion system comprises an input unit 100, a plurality of input capacitors 360˜362, a plurality of PWM signal generators 340˜342, a micro-processor 370 and a plurality of filters 350˜352. The PWM signal generators 340-342 are connected with the input unit 100 respectively. An input voltage-current 110 is transmitted to the PWM signal generators 340˜342 via the input unit 100. The input capacitors 360˜362 are coupled between the input unit 100 and the PWM signal generators 340˜342 for reducing the ripple. The PWM signal generators 340˜342 is used for generating the PWM signals 230˜232 corresponding to the input voltage-current 110. When the PWM signal generators 340˜342 are enabled, they will output power-good (PGD) signals.

The micro-processor 370 is connected with the plurality PWM signal generators 340˜342 respectively for receiving the PGD signals PGD1˜PGD3 which are outputted by the PWM signal generators 340˜342 and counts the number of the PWM signal generators 340˜342 and determines the order of the PWM signal generators 340˜342 based on these PGD signals. Then, the micro-processor 370 transmits the data signal 380 containing the number and the order to the PWM signal generators 340˜342.

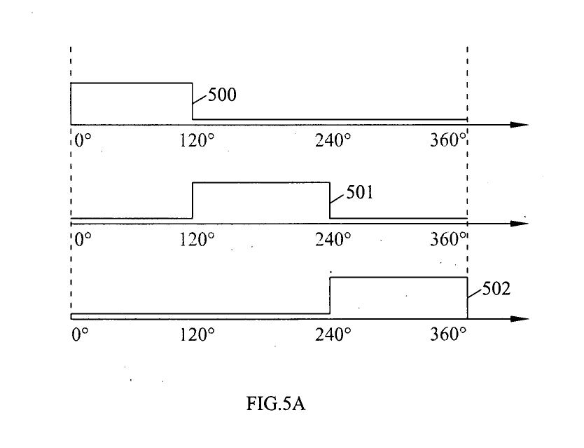

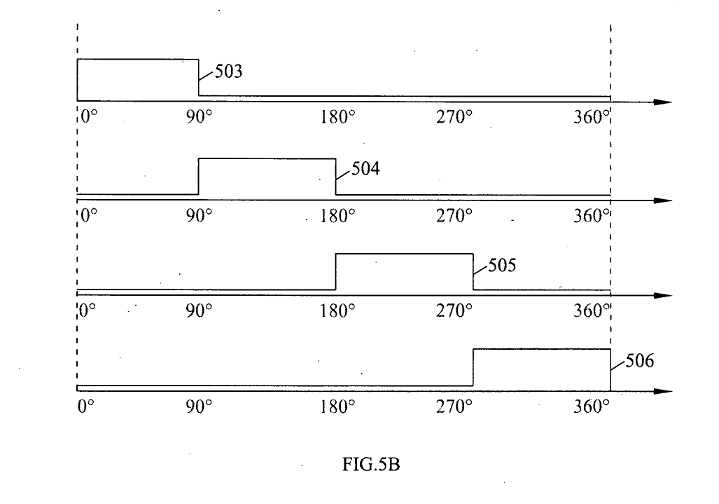

After receiving the data signal 380 transmitted by the micro-processor 370, the PWM signal generators 340˜342 calculate the phases and the phase order of the PWM signal signals 230˜232, based on a formula (360°/number) and the order of the PWM signal generators 340˜342, to generate the PWM signals 230˜232 with asynchronous phases. For instance, as shown in FIG. 5A, when three PWM signal generators are provided in the asynchronous power conversion system of the invention, these three PWM signal generators will generate three PWM signals 500˜502 of which phases are 0°, 120° and 240° respectively. As shown in FIG. 5B, when four PWM signal generators are provided in the asynchronous power conversion system of the invention, these four PWM signal generators will generate four PWM signals 503˜506 of which phases are 0°, 90°, 180° and 270° respectively. The filters 350˜352 are for filtering the PWM signals 230˜232 and then outputting the working voltage-current 220˜222 corresponding to the PWM signals 230˜232 respectively for driving the loads 170˜172.

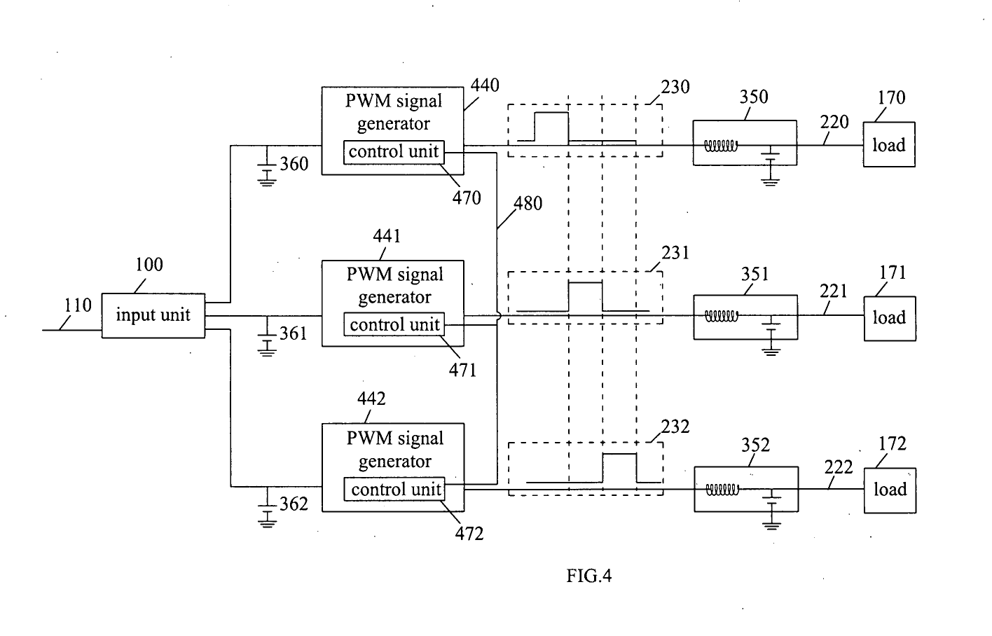

FIG. 4 illustrates a block diagram of the second embodiment of power conversion system in accordance with the present invention. The power conversion system comprises an input unit 100, a plurality of input capacitors 360˜362, a plurality of PWM signal generators 440˜442 and a plurality of filters 350˜352. The difference between the second embodiment and the first embodiment is that the control units 470˜472 are integrated into the PWM signal generators 440˜442 separately and are connected electrically each other. After the PWM signal generators 440˜442 are enabled, the control units 470˜472 communicate each other via the data signal 480 for counting the number of the PWM signal generators 440˜442 and detecting the order of the PWM signal generators 440˜442.

While receiving the input voltage-current 110 from the input unit 100, the PWM signal generators 440˜442 generate the PWM signals 230˜232 corresponding to the input voltage-current 110 respectively, and then determine the phases and the phase order of the PWM signal 230˜232 based on a formula (360°/number) and the order of the PWM signal generators 440˜442, so that the phases of PWM signals 230˜232 can be asynchronous. The filters 350˜352 output the working voltage-currents 220˜222 corresponding to the PWM signals 230˜232 respectively for driving the loads 170˜172.

Because the phase of the PWM signals are asynchronous, the ripple can be reduced efficiently, and the required input capacitors 360˜362 can be reduced and the PCB area required by input capacitor and the electromagnetic interference also can be decreased. While the calculation means of phase has been described in terms of an embodiment, it is to be understood that the invention is not limited thereto. To the contrary, it is intended to cover various modification and arrangements of asynchronous signals generated by the PWM units.

The characteristic of the present invention is that the power conversion system can adjust the phases of the PWM signals automatically based on the number of the PWM units provided by user. For example, in design of the main board module, while the number of the loads of the main board module changes, the system designer can adjust the number of the PWM signal generators based on the number of the loads without complex setting. Then, the power conversion system in accordance with the invention can dynamically adjust the phases of the PWM signals for fitting the new main board module.

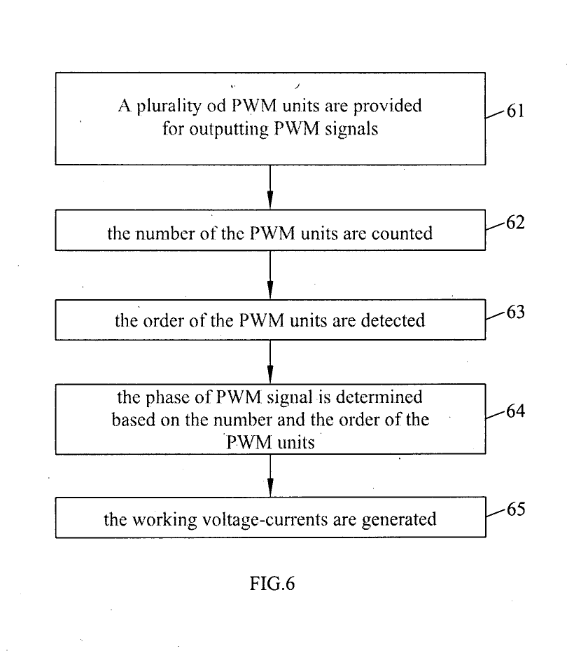

FIG. 6 illustrates a flow diagram of the power conversion method in accordance with the present invention. The power conversion method is applied in power conversion system for converting an input voltage-current to a plurality of working voltage-currents and includes the following steps. In step 61, a plurality of PWM units are provided in the power conversion system for outputting a plurality of PWM signals corresponding to the input voltage-current. In step 62 the number of the PWM units is counted automatically, and the order of the PWM units is also detected automatically in step 63.

Preferably, the step 62 and step 63 can be executed by a discrete controller such as a micro-processor or an embedded controller (EC). The discrete controller is connected with all PWM units, and receives the trigger signals generated from the PWM units when PWM units are enabled, and then counts the number of the PWM units and detects the order of the PWM units, and then sends a data signal containing the number and the order to the PWM units.

Besides, the step 62 and step 63 also can be executed by a plurality of control elements, and each control element is integrated with each PWM unit, and all the control elements are connected each other. After the PWM units are enabled, the control elements will communicate to each other for counting the number of the PWM units and detecting the order of the PWM units.

In step 64, the PWM units determine the phase of the PWM signals based on the number of the PWM units for ensuring the phases of the PWM signals are asynchronous. Preferably, the phase is determined by dividing 360° by the number of the PWM units. In step 65 the working voltage-current corresponding to the PWM signal is generated. Preferably, the step 65 can be executed by a filter.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power conversion system comprising:
an input unit for providing an input voltage-current;
a plurality of pulse width modulation (PWM) units connected to said input unit respectively, for receiving said input voltage-current and outputting PWM signals corresponding to said input voltage-current;
a control unit connected with said PWM units for counting the number of said PWM units and detecting the order of said PWM units; and
a plurality of conversion units connected with said PWM units respectively for generating working voltage-currents corresponding to said PWM signals;
wherein said PWM units determine the phases of said PWM signals based on the number and the order of said PWM units.

2. A power conversion system of claim 1, wherein said phases of said PWM signals are determined by dividing 360° by said number of said PWM units.

3. A power conversion system of claim 1, wherein said PWM signals are asynchronous.

4. A power conversion system of claim 1, wherein said control unit is a discrete unit.

5. A power conversion system of claim 1, wherein said control unit can be integrated into said PWM units.

6. A power conversion system of claim 1, wherein said transformation unit is a filter.

7. Method of converting an input voltage-current into working voltage-currents including the steps of:
providing a plurality of PWM units which are used to generate a plurality of PWM signals corresponding to said input voltage-current;
counting the number of said PWM units;
detecting the order of said PWM units;
determining the phases of said PWM signals by said PWM units based on the number and the order of said PWM units; and
generating said working voltage-currents corresponding to said PWM signals.

8. Method of claim 7, wherein said phases of said PWM signals is determined by dividing 360° by said number of said PWM units.

9. Method of claim 7, wherein said PWM signals are asynchronous.

10. Method of claim 7, wherein the step of generating said working voltage-currents is accomplished by a filter.
